(19) United States
(12) Patent Application Publication
(10) Pub. No.: US 2020/0218316 A1
(43) Pub. Date: Jul. 9, 2020

(54) Display Substrate, Method for Preparing the Same, and Display Motherboard

(71) Applicants: BOE TECHNOLOGY GROUP CO., LTD., Beijing (CN); HEFEI XINSHENG OPTOELECTRONICS TECHNOLOGY CO., LTD., Hefei, Anhui (CN)

(72) Inventors: Xiaozhe ZHANG, Beijing (CN); Guohua WANG, Beijing (CN); Xiong XIONG, Beijing (CN)

(21) Appl. No.: 15/751,573

(22) PCT Filed: Aug. 1, 2017
(86) PCT No.: PCT/CN2017/095395

§ 371 Date: Feb. 9, 2018

(30) Foreign Application Priority Data
Dec. 15, 2016 (CN) 201611164534.3

(51) Int. Cl. G06F 1/18; G02F 1/1339; G02F 1/1335

(52) U.S. Cl. CPC G06F 1/184; G02F 1/133514; G02F 1/13394

(57) ABSTRACT

The present disclosure provides a display substrate, a method for preparing the same, and a display motherboard. The display substrate comprises: a plurality of display areas spaced apart from each other, each of which is provided with a plurality of spacers; and a blank area between any two adjacent display areas of the plurality of display areas, and provided with a plurality of supporters having the same material and height as the spacers. Since the blank area is provided with the supporters in the display substrate of this disclosure, the problem with uneven cell gap between the blank area and the display area under an action of atmospheric pressure is effectively avoided, thereby preventing the phenomenon that the display motherboard at a place with a greater cell gap presents a yellow color when displaying.

### CROSS-REFERENCE TO RELATED APPLICATION

This application claims the priority of Chinese Patent Application No. 201611164534.3 submitted to the Chinese Intellectual Property Office on Dec. 15, 2016, the disclosure of which is incorporated herein in its entirety by reference.

### TECHNICAL FIELD

The present disclosure relates to the technical field of display technology, and particularly relates to a display substrate, a method for preparing the same, and a display motherboard.

### BACKGROUND OF THE INVENTION

As shown in FIG. 1, the display motherboard typically includes two display substrates 10, 20 (which may be a color filter substrate and an array substrate) bonded by a sealant, and a supporting spacer PS between the two display substrates to maintain a cell gap. For each display motherboard, it may be cut along a cutting area (i.e., the blank area Q2) into a plurality of display panels.

Since the display motherboard has a larger size, in order to form corresponding display devices accurately at corresponding locations in the display area Q1 of the display substrate, a window (i.e., an alignment mark) is typically formed in the blank area Q2 of the display substrate. However, the presence of the window results in a larger width of the blank area Q2. In this case, when two display substrates are assembled, since the blank area Q2 is not supported by the spacer PS, stress is concentrated on the blank area Q2 and the cell gap therein subsequently becomes smaller under an action of atmospheric pressure, thus causing the substrate at the periphery of the blank area Q2 to warp due to different forces thereupon (shown by dash lines in FIG. 1) and the cell gap to become greater at the periphery, and further resulting in the display motherboard at a place with the greater cell gap presenting a yellow color when displaying.

### SUMMARY

The present disclosure has been accomplished in order to at least partially solve the problems in the prior art. The present disclosure provides a display substrate, a method for preparing the same, and a display motherboard that can improve the following technical problem: due to a larger width of the blank area, the substrate at the periphery of the blank area warps under an action of atmospheric pressure due to different forces thereupon, thus causing the display motherboard presenting a yellow color when displaying.

According to one aspect of the disclosure, there is provided a display substrate, comprising:

a plurality of display areas spaced apart from each other, each of which is provided with a plurality of spacers; and

a blank area between any two adjacent display areas of the plurality of display areas, and provided with a plurality of supporters having the same material and height as the spacers.

The plurality of supporters may be uniformly distributed on the blank area.

The blank area may be provided with a window disposed correspondingly to the supporter.

The supporter may have the same shape as the spacer.

The display substrate may further include a color filter layer disposed within the display area and a protective layer disposed above the color filter layer.

According to another aspect of the disclosure, there is provided a method for preparing the above mentioned display substrate, comprising:

step S1: forming the display substrate comprising a display area and a blank area; and

step S2: forming a plurality of spacers on the display area, and forming a plurality of supporters on the blank area.

The step S1 may include:

S11: forming a color filter layer on a substrate within the display area; and

S12: forming a protective layer above the color filter layer.

The step S2 may include: forming the spacer and the supporter simultaneously in one patterning process.

According to still another aspect of the disclosure, there is provided a display motherboard comprising an assembling substrate and the above mentioned display substrate, wherein the spacer and the supporter are located between the assembling substrate and the display substrate.

### BRIEF DESCRIPTION OF THE FIGURES

FIG. 1 is a structural schematic view showing a display motherboard of the prior art;

FIG. 2 is a structural schematic view showing the display substrate according to the first exemplary embodiment of the disclosure; and

FIG. 3 is a schematic view showing steps of the method for preparing the display substrate according to the second exemplary embodiment of the disclosure.

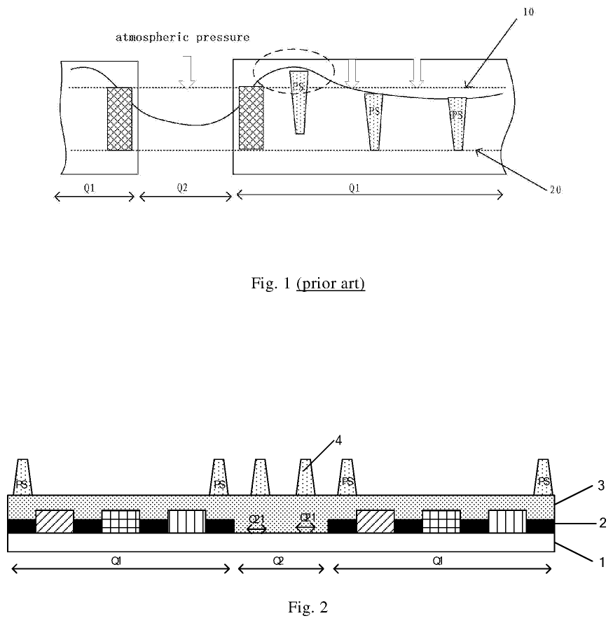

### DETAILED DESCRIPTION

To improve understanding of the technical solution of the present disclosure for those skilled in the art, the present disclosure will be described below in detail in conjunction with the accompanying drawings and specific embodiments.

### First Exemplary Embodiment

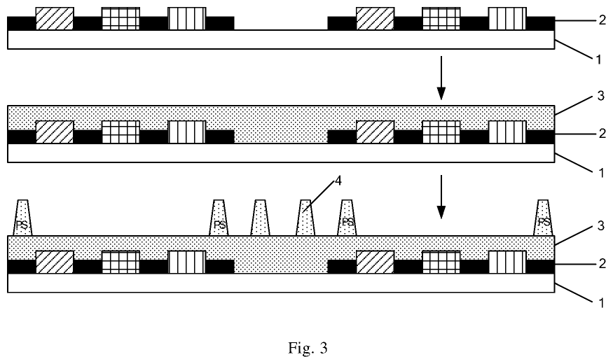

FIG. 2 is a structural schematic view showing the display substrate according to the first exemplary embodiment of the disclosure. According to one aspect of the disclosure, as shown in FIG. 2, this exemplary embodiment provides a display substrate, comprising: a plurality of display areas Q spaced apart from each other, each of which is provided with a plurality of spacers PS; and a blank area Q2 between any two adjacent display areas of the plurality of display areas Q1, and provided with a plurality of supporters 4 having the same material and height as the spacers PS.

It should be noted that the display substrate in this exemplary embodiment is a substrate used for forming a display motherboard together with an assembling substrate. Display area Q1 refers to a position corresponding to individual display areas of the plurality of display substrates, and blank area Q2 refers to a position between any two adjacent display substrates.

Since the blank area Q2 is provided with supporters 4 in the display substrate of this exemplary embodiment, when the display substrate and the assembling substrate are assembled, the problem with uneven cell gap between the blank area Q2 and the display area Q1 under an action of atmospheric pressure is effectively avoided, thereby solving the problem that the cell gap of the blank area Q2 becomes smaller, causing an assembling substrate at the periphery of the blank area Q2 to warp and the cell gap at the periphery to become greater, and further resulting in the display motherboard at a place with the greater cell gap presenting a yellow color when displaying. In addition, the supporter 4 in this exemplary embodiment has the same material and height as the spacer PS. Thus, the spacer and the supporter may be simultaneously formed in one patterning process without increasing process steps or cost.

In an exemplary embodiment according to the disclosure, in order to ensure the evenness of the cell gap after the display substrate and the assembling substrate are assembled, a plurality of supporters 4 are uniformly distributed on the blank area Q2.

In an exemplary embodiment according to the disclosure, a window Q21, i.e., an alignment mark, for alignment and measurement is disposed in the blank area Q2 of the display substrate. The presence of the window Q21 results in a larger width of the blank area Q2. In order to prevent the cell gap of the wider blank area Q2 becoming smaller under an action of atmospheric pressure, in an exemplary embodiment according to the disclosure, the supporter 4 is disposed at a position where the window Q21 is located, so as to fill the window Q21. That is, the supporter 4 and the window Q21 are correspondingly disposed. In this way, the following technical problem in the prior art is solved: the cell gap of the blank area Q2 becomes smaller, causing an assembling substrate at the periphery of the blank area Q2 to warp and the cell gap at the periphery to become greater, and further resulting in the display motherboard at a place with the greater cell gap presenting a yellow color when displaying.

In an exemplary embodiment according to the disclosure, the supporter 4 has the same shape as the spacer PS so as to facilitate preparation.

Further, since the spacer PS is typically disposed on a color filter substrate, in an exemplary embodiment according to the disclosure, the display substrate is a color filter substrate, i.e., the display substrate further includes a color filter layer 2 (typically including a red filter, a green filter, a blue filter and a black array between two adjacent filters) and a protective layer 3 between the color filter layer 2 and the spacer PS.

Obviously, the display substrate in this exemplary embodiment is not limited to color filter substrate, but may also be an array substrate or COA (Color on Array) substrate and the like.

### Second Exemplary Embodiment

FIG. 3 is a schematic view showing steps of the method for preparing the display substrate according to the second exemplary embodiment of the disclosure. According to another aspect of the disclosure, this exemplary embodiment provides a method for preparing a display substrate, wherein the display substrate may be the display substrate of the first exemplary embodiment. The method comprises: step S1: forming a display substrate comprising a display area Q1 and a blank area Q2; and step S2: forming a plurality of spacers PS on the display area Q1, and forming a plurality of supporters 4 on the blank area Q2.

Hereinafter, the specific steps of the method for preparing the display substrate in this exemplary embodiment will be described with reference to FIGS. 2 and 3 assuming that the display substrate is a color filter substrate.

Specifically, the above step S1 includes:

S11: forming a color filter layer 2 on a substrate 1 within the display area Q1.

In an exemplary embodiment according to the disclosure, the color filter layer 2 includes a red filter, a green filter, a blue filter and a black array between two adjacent filters.

Each of the red filter, the green filter, the blue filter and the black array is formed by firstly forming a corresponding color resist on the substrate 1 in a spin coating method, and in order to shorten dry time of the color resist, the color resist may experience a pre-baking treatment at a temperature between approximately 30 and 140° C. Obviously, the baking temperature may be specifically set according to specific situations. The duration time may be approximately 1 to 10 min. Then, the color resist goes through an exposure process with a mask plate. Finally, the color filter of a corresponding color or the black array obtained in the display area Q1 goes through a developing process.

S12: forming a protective layer 3 above the color filter layer.

In addition, the step S2 includes: forming patterns of the spacer PS on the display area Q1 and of the supporter 4 on the blank area Q2 simultaneously in one patterning process.

Since the blank area Q2 is provided with the supporters 4 in the method for preparing the display substrate in this exemplary embodiment, when the display substrate and the assembling substrate are assembled, the problem with uneven cell gap between the blank area Q2 and the display area Q1 under an action of atmospheric pressure is effectively avoided, thereby solving the problem that the cell gap of the blank area Q2 becomes smaller, causing an assembling substrate at the periphery of the blank area Q2 to warp and the cell gap at the periphery to become greater, and further resulting in the display motherboard at a place with the greater cell gap presenting a yellow color when displaying. In addition, the supporter 4 and the spacer PS in this exemplary embodiment are simultaneously formed in one patterning process without increasing process steps or cost.

### Third Exemplary Embodiment

According to still another aspect of the disclosure, this exemplary embodiment provides a display motherboard comprising an assembling substrate and the display substrate of the first exemplary embodiment, wherein the supporter 4 and the spacer PS are located between the assembling substrate and the display substrate.

Since the blank area Q2 is provided with the supporters 4 in display substrate of the first exemplary embodiment, for the display motherboard in this exemplary embodiment, the problem with uneven cell gap between the blank area Q2 and the display area Q under an action of atmospheric pressure is effectively avoided, thereby solving the problem that the cell gap of the blank area Q2 becomes smaller, causing an assembling substrate at the periphery of the blank area Q2 to warp and the cell gap at the periphery to become greater, and further resulting in the display motherboard at a place with the greater cell gap presenting a yellow color when displaying. In addition, the supporter 4 in this exemplary embodiment has the same material and height as the spacer PS. Thus, the spacer and the supporter may be simultaneously formed in one patterning process without increasing process steps or cost.

In an exemplary embodiment according to the disclosure, the display motherboard may be an electronic paper, a mobile phone, an LC panel, a television, a monitor, a notebook computer, a digital album, a navigator or any other products or components having a display function.

It should be understood that the above embodiments are merely exemplary embodiments for the purpose of illustrating the principle of the disclosure, and the disclosure is not limited thereto. Various modifications and improvements can be made by a person having ordinary skill in the art without departing from the spirit and essence of the disclosure. Accordingly, all of the modifications and improvements also fall into the protection scope of the disclosure.

1. A display substrate, comprising:
a plurality of display areas spaced apart from each other, each of which is provided with a plurality of spacers; and
a blank area between any two adjacent display areas of the plurality of display areas, and provided with a plurality of supporters having the same material and height as the spacers.

2. The display substrate according to claim 1,
wherein the plurality of supporters are uniformly distributed on the blank area.

3. The display substrate according to claim 1,
wherein the blank area is provided with a window disposed correspondingly to the supporter.

4. The display substrate according to claim 1,
wherein the supporter has the same shape as the spacer.

5. The display substrate according to claim 1,
wherein the display substrate further comprises a color filter layer disposed within the display area and a protective layer disposed above the color filter layer.

6. A method for preparing the display substrate according to claim 1, comprising:
step S1: forming the display substrate comprising a display area and a blank area; and
step S2: forming a plurality of spacers on the display area, and forming a plurality of supporters on the blank area.

7. The method for preparing the display substrate according to claim 6, wherein the step S1 comprises:
S11: forming a color filter layer on a substrate within the display area; and
S12: forming a protective layer above the color filter layer.

8. The method for preparing the display substrate according to claim 6,
wherein the step S2 comprises forming the spacer and the supporter simultaneously in one patterning process.

9. A display motherboard, comprising an assembling substrate and the display substrate according to claim 1, wherein the spacer and the supporter are located between the assembling substrate and the display substrate.
